(19) United States
(12) Patent Application Publication
(10) Pub. No.: US 2008/0219702 A1
(43) Pub. Date: Sep. 11, 2008

(54) IMAGE FORMING APPARATUS, PROCESS CARTRIDGE, AND IMAGE FORMING METHOD

(76) Inventors: Takeo TSUKAMOTO, Kanagawa (JP); Katsuhiro Aoki, Kanagawa (JP); Kei Yasutomi, Kanagawa (JP); Hitoshi Maruyama, Tokyo (JP); Masanori Saitoh, Tokyo (JP); Katsuaki Miyawaki, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/042,892

(22) Filed: Mar. 5, 2008

(30) Foreign Application Priority Data
Mar. 6, 2007 (JP) 2007-055998

(51) Int. Cl. G03G 15/02; G03G 13/06

(52) U.S. Cl. 399/168; 430/97

(57) ABSTRACT

A disclosed image forming apparatus includes an image carrier; one or more charging units configured to charge the image carrier in preparation for formation of each of plural latent images corresponding to toner images of different colors; a latent image forming unit configured to expose non-image areas on the charged image carrier to form each of the latent images; and developing units configured to develop the corresponding latent images in sequence with toners of the corresponding colors to form the toner images and thereby to form a color toner image composed of the toner images of the different colors on the image carrier, the toners having polarity opposite to that of the charged image carrier.

### BACKGROUND OF THE INVENTION

1. Field of the Invention

The present invention generally relates to an image forming apparatus such as a copier, a fax machine, and a printer, a process cartridge attachable/detachable to/from the image forming apparatus, and an image forming method. More particularly, the present invention relates to an image forming apparatus, a process cartridge, and an image forming method for forming a multicolor image by superposing toner images of different colors on one image carrier.

2. Description of the Related Art

Tandem electrophotographic methods, which employ multiple photoconductors, are widely used for high-speed color printing. One disadvantage of a tandem electrophotographic method is that it complicates the structure of an imaging engine and increases the size and cost of the imaging engine due to its use of multiple photoconductors. To eliminate or lesson this problem, an image-on-image development method has been proposed. In the image-on-image development method, toner images of different colors are superposed on one photoconductor (see, for example, patent documents 1 and 2) to form a multicolor image.

FIG. 24 shows a conventional imaging unit that forms a multicolor image by the image-on-image development method. In a typical imaging unit, a latent image is formed by reducing the electric potential of image areas (where a toner image is to be formed) on a photoconductor uniformly charged by a charging unit. The latent image is then developed with toner having the same polarity as the charge polarity of the photoconductor surface to form a toner image.

In the imaging unit shown in FIG. 24, a charging unit 21 uniformly charges the surface of a photoconductor 30 to negative polarity and an exposing unit (not shown) forms a latent image by exposing the surface of the photoconductor 30 with a laser beam L. Then, a developing unit 41 forms a first toner image of a first color by developing the latent image with toner of the first color having negative polarity. Next, a charging unit 22 charges the surface of the photoconductor 30 and the first toner image to negative polarity and the exposing unit forms a latent image by exposing the surface of the photoconductor 30 through the first toner image with the laser beam L. Then, a developing unit 42 forms a second toner image of a second color over the first toner image by developing the latent image with toner of the second color having negative polarity. These steps are repeated for the number of colors and, as a result, toner images of different colors are formed on the photoconductor 30.

FIGS. 25A through 25E are graphs showing electric potentials of the surface of the photoconductor 30 and the toner images in the exemplary imaging process described above with reference to FIG. 24. The charging unit 21 charges the photoconductor 30 to −600 V as shown in FIG. 25A. Then, the exposing unit exposes image areas on the photoconductor 30 to form a latent image. The surface potential of the exposed image areas of the photoconductor 30 becomes −50 V as shown in FIG. 25B. Next, the developing unit 41 develops the latent image with the toner of the first color to form the first toner image. In this development step, the toner adheres to the photoconductor 30 due to a development potential difference (difference between the potential of the exposed image areas and a development bias potential) of about 300 V shown in FIG. 25B. Because toner itself has an electric charge, the toner image has an electric potential (toner image potential) of about 100 V as shown in FIG. 25C. The charging unit 22 charges the photoconductor 30 and the first toner image to make the surface potentials of the photoconductor 30 and the first toner image substantially the same. However, because the first toner image absorbs negative ions emitted from the charging unit 22, the toner image potential increases as shown in FIG. 25D. With the toner image potential, if the exposing unit exposes a toner-image-present portion of the photoconductor 30 where the first toner image is present and a toner-image-absent portion where the first toner image is not present with the same light intensity, the development potential difference in the toner-image-present portion becomes smaller than that in the toner-image-absent portion as shown in FIG. 25E. This in turn causes the amounts of toner adhering to the toner-image-present portion and the toner-image-absent portion to differ greatly and thereby causes the density of developed toner images to vary.

Therefore, to form a high-quality image by the image-on-image development method, it is necessary to reduce the influence of the toner image potential of a preceding toner image on the formation of a subsequent toner image.

Patent document 3 discloses an image forming apparatus including a discharging unit that discharges an image carrier and a preceding toner image before a charging unit charges the image carrier and the preceding toner image to form a subsequent toner image. The discharging unit discharges the image carrier and the preceding toner image by charging the image carrier and the preceding toner image to a polarity opposite to their current polarity. Thus, the disclosed image forming apparatus is designed to reduce the influence of the toner image potential of a preceding toner image on the formation of a subsequent toner image.

[Patent document 1] Japanese Patent Application Publication No. 8-087179

[Patent document 2] Japanese Patent Application Publication No. 10-003191

[Patent document 3] Japanese Patent Application Publication No. 8-286456

However, the configuration of the image forming apparatus disclosed in patent document 3 requires a dedicated discharging unit for discharging the image carrier and the preceding toner image, and therefore increases the size of the image forming apparatus. In particular, to apply the configuration of patent document 3 to an image forming apparatus that forms toner images of all colors on an image carrier while the image carrier rotates once, it is necessary to provide a separate discharging unit for at least each one of the constituent colors except for the last color and therefore necessary to greatly increase the size of the image forming apparatus.

### SUMMARY OF THE INVENTION

Embodiments of the present invention provide an image forming apparatus, a process cartridge, and an image forming method that solve or reduce one or more problems caused by the limitations and disadvantages of the related art.

An embodiment of the present invention provides an image forming apparatus that includes an image carrier; one or more charging units configured to charge the image carrier in preparation for formation of each of latent images corresponding to toner images of different colors; a latent image forming unit configured to expose non-image areas on the charged image carrier to form each of the latent images; and developing units configured to develop the corresponding latent images in sequence with toners of the corresponding colors to form the toner images and thereby to form a color toner image composed of the toner images of the different colors on the image carrier, the toners having polarity opposite to that of the charged image carrier.

Another embodiment of the present invention provides a method for forming a color toner image composed of multiple toner images of different colors on an image carrier of an image forming apparatus. The method includes the steps of charging the image carrier in preparation for formation of each of latent images corresponding to the toner images of the different colors; exposing non-image areas on the charged image carrier to form each of the latent images; and developing the latent images in sequence with toners of the corresponding colors to form the toner images and thereby to form the color toner image on the image carrier, the toners having polarity opposite to that of the charged image carrier.

### BRIEF DESCRIPTION OF THE DRAWINGS

FIGS. 1A through 1E are graphs showing electric potentials of the surface of a photoconductive drum and a toner image according to a first embodiment of the present invention;

FIG. 2 is a schematic diagram of a printer according to an embodiment of the present invention;

FIG. 3 is a schematic diagram of an imaging unit according to the first embodiment;

FIG. 4 is a schematic diagram of a developing unit according to a second embodiment of the present invention;

FIG. 5 is an enlarged view of the surface layers of a toner carrying roller;

FIG. 6 is a drawing illustrating waveforms of voltages applied to electrodes arranged at intervals;

FIG. 7 is a drawing illustrating a toner cloud formed when voltages of different waveforms are applied alternately to electrodes arranged at intervals;

FIGS. 8A through 8E are graphs showing electric potentials of the surface of a photoconductive drum and a toner image according to the second embodiment;

FIG. 9 is a schematic diagram of a developing unit according to a third embodiment of the present invention;

FIG. 10 is an enlarged view of the surface layers of a toner carrying roller;

FIG. 11 is a drawing illustrating a toner cloud formed when voltages of different waveforms are applied one after the other to electrodes arranged at intervals;

FIG. 12 is a drawing illustrating waveforms of voltages applied to electrodes arranged at intervals;

FIG. 13 is a schematic diagram of an imaging unit according to a fourth embodiment of the present invention;

FIGS. 14A through 14E are graphs showing electric potentials of the surface of a photoconductive drum and a toner image according to the fourth embodiment;

FIG. 15 is a schematic diagram of a developing unit according to a fifth embodiment of the present invention;

FIG. 16 is an enlarged view of the surface layers of a toner carrying roller;

FIG. 17 is a drawing illustrating waveforms of voltages applied to electrodes arranged at intervals;

FIG. 18 is a drawing illustrating a toner cloud formed when voltages of different waveforms are applied alternately to electrodes arranged at intervals;

FIGS. 19A through 19E are graphs showing electric potentials of the surface of a photoconductive drum and a toner image according to the fifth embodiment;

FIG. 20 is a schematic diagram of a developing unit according to a sixth embodiment of the present invention;

FIG. 21 is an enlarged view of the surface layers of a toner carrying roller;

FIG. 22 is a drawing illustrating a toner cloud formed when voltages of different waveforms are applied one after the other to electrodes arranged at intervals;

FIG. 23 is a drawing illustrating waveforms of voltages applied to electrodes arranged at intervals;

FIG. 24 is a schematic diagram of a conventional imaging unit; and

FIGS. 25A through 25E are graphs showing electric potentials of the surface of a photoconductive drum and a toner image in a conventional image forming apparatus.

### DESCRIPTION OF THE PREFERRED EMBODIMENTS

Preferred embodiments of the present invention are described below with reference to the accompanying drawings.

In embodiments of the present invention, a printer is used as an example of an image forming apparatus. An exemplary configuration and exemplary operations of a printer according to an embodiment of the present invention are described below.

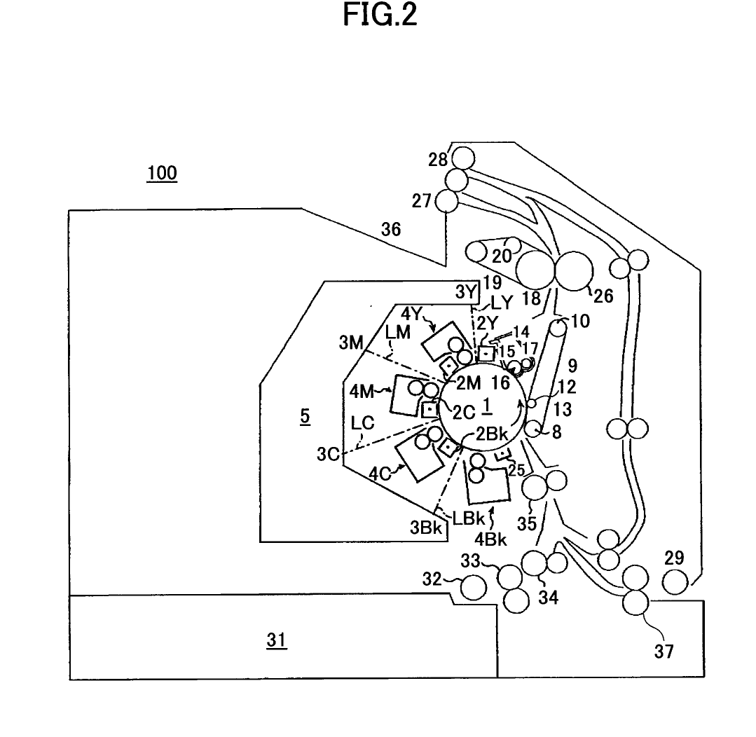

FIG. 2 is a schematic diagram of a printer 100 according to an embodiment of the present invention. The printer 100 includes an imaging unit in the central part of its body and the imaging unit includes a photoconductive drum 1. Four sets of a charging unit 2 and a developing unit 4 for forming toner images of yellow (Y), magenta (M), cyan (C), and black (Bk), respectively, are disposed counterclockwise around the photoconductive drum 1 in the order mentioned. An exposing unit (latent image forming unit) 5 is disposed to the left of the photoconductive drum 1. The exposing unit 5 includes exposing components 3Y, 3M, 3C, and 3Bk for illuminating the photoconductive drum 1 with the corresponding laser beams L (LY, LM, LC, and LBk). The exposing components 3 expose the photoconductive drum 1 at the corresponding positions between the charging units 2 and the developing units 4 to form latent images for yellow (Y), magenta (M), cyan (C), and black (Bk) toner images. More specifically, the charging units 2, the exposing components 3, and the developing units 4 are arranged counterclockwise around the photoconductive drum 1 in the following order: the charging unit 2Y, the exposing component 3Y, and the developing unit 4Y for yellow; the charging unit 2M, the exposing component 3M, and the developing unit 4M for magenta; the charging unit 2C, the exposing component 3C, and the developing unit 4C for cyan; and the charging unit 2Bk, the exposing component 3Bk, and the developing unit 4Bk for black. In addition, at positions downstream of the above units (the charging units 2, the exposing components 3, and the developing units 4), a transfer belt unit 9 and a cleaning unit 14 are provided. In this embodiment, the photoconductive drum 1, the charging units 2, the developing units 4, and the cleaning unit 14 constitute the imaging unit and are integrated as a process cartridge that is removably attached to the printer 100. The configuration of the process cartridge is not limited to that described above. Also, the imaging unit is not necessarily integrated as a process cartridge.

Below, for descriptive purposes, the charging units 2Y, 2M, 2C, and 2Bk, the exposing components 3Y, 3M, 3C, and 3B, and the developing units 4Y, 4M, 4C, and 4Bk may be collectively referred to as the charging unit 2, the exposing component 3, and the developing unit 4.

The charging unit 2 is implemented by a scorotron charger and is supplied with a voltage (e.g., a DC voltage) from a power-supply unit (not shown) in the printer 100. The charging unit 2 uniformly charges the photoconductive layer of the photoconductive drum 1 made of an organic photoreceptor by a grid maintained at a predetermined potential and a corona discharge wire.

The exposing unit 5 radially emits four laser beams L onto the photoconductive drum 1. More specifically, the exposing components 3 of the exposing unit 5 expose the uniformly charged photoconductive drum 1 at the corresponding positions with the laser beams L to form latent images for the respective colors. The exposing components 3 of the exposing unit 5 may be implemented by separate light emitting units or LED arrays.

The developing unit 4 includes a developing roller facing the photoconductive drum 1. The developing roller electrostatically attracts toner and carries the toner to a developing zone of the photoconductive drum 1.

The transfer belt unit 9 includes a drive roller 10, a driven roller 8, a transfer roller 12, and a transfer belt 13 stretched over the rollers. A portion of the transfer belt 13 is in contact with the surface of the photoconductive drum 1. The transfer roller 12 is disposed to contact the inner side of the portion of the transfer belt 13. The portion of the transfer belt 13 is called a transfer area and the transfer roller 12 causes a toner image on the photoconductive drum 1 to be transferred onto a recording medium being carried by the transfer belt 13 in the transfer area. The transfer belt 13 is, for example, an endless belt. The endless belt is composed of a semiconductive substrate made of silicon rubber or polyurethane rubber and having a volume resistivity between 10⁸ and 10¹² Ω·cm and a thickness between 0.5 and 2.0 mm, and a semiconductive surface layer made of a fluorine coating having a thickness between 5 and 50 μm. The semiconductive surface layer is provided to prevent a “toner filming” phenomenon. Instead of the semiconductive substrate made of rubber, a layer made of semiconductive polyester, polystyrene, polyethylene, or polyethylene terephthalate and having a thickness between 0.1 and 0.5 mm may be used. The transfer belt unit 9 also includes a belt cleaning unit (not shown) for cleaning the surface of the transfer belt 13.

The cleaning unit 14 includes a cleaning blade 15, a fur brush 16, and a cleaning screw 17. Alternatively, the cleaning unit 14 may be composed solely of the cleaning blade 15.

A fusing unit 18 is disposed downstream of the transfer belt unit 9 with respect to the direction in which a recording medium is carried. The fusing unit 18 includes a tension roller 20, two supporting rollers, an endless fusing belt 19 stretched over the tension roller 20 and the supporting rollers, and a pressure roller 26 pressed against the fusing belt 19.

A paper-feeding cassette 31 containing recording media (e.g., paper), a first paper-feeding roller 32 for feeding a recording medium from the paper-feeding cassette 31, and second paper-feeding rollers 33 are disposed in the lower part of the printer 100. Conveying rollers 34 and resist rollers 35 are disposed along a paper-feeding path leading to the transfer belt 13. A paper-ejecting roller 27 for ejecting a recording medium onto a paper catch tray 36 on the upper side of the printer 100 is disposed downstream of the fusing unit 18. Reverse-feeding rollers 28 for reversing a recording medium and feeding it back into the imaging unit are disposed above the paper-ejecting roller 27. Also, three pairs of conveying rollers are disposed along a reverse-feeding path leading to the resist rollers 35. Further, a manual paper feed unit is provided in the lower-right part of the printer 100. The manual paper feed unit includes a pick-up roller 29 and paper-feeding rollers 37.

Next, operations of the printer 100 are described.

For example, image data scanned by an imaging device of a scanner or processed by a computer are stored in a memory of the printer 100 as image signals corresponding to Y, M, C, and Bk colors. When a print process is started, a photoconductor drive motor (not shown) rotates the photoconductive drum 1 counterclockwise and the charging unit 2Y charges the photoconductive drum 1. Then, the exposing unit 5 exposes the charged photoconductive drum 1 being rotated with the laser beam LY according to a yellow image signal and thereby forms a latent image Y corresponding to a yellow image in the image data on a photoconductive layer of the photoconductive drum 1. The developing unit 4Y develops without contact the latent image Y with a yellow toner carried by the developing roller to a position facing the photoconductive drum 1 and thereby forms a yellow toner image on the photoconductive drum 1.

Next, the charging unit 2M charges the photoconductive drum 1 and the yellow toner image. The exposing unit 5 exposes the charged photoconductive drum 1 through the yellow toner image with the laser beam LM according to a magenta image signal and thereby forms a latent image M corresponding to a magenta image in the image data. The developing unit 4M develops without contact the latent image M with a magenta toner carried by the developing roller to a position facing the photoconductive drum 1 and thereby forms a magenta toner image over the yellow toner image. Similarly, a cyan toner image corresponding to a cyan image in the image data is formed by the charging unit 2C, the exposing unit 5, and the developing unit 4C over the magenta toner image, and a black toner image corresponding to a black image in the image data is formed by the charging unit 2Bk, the exposing unit 5, and the developing unit 4Bk over the cyan toner image. Thus, toner image of four colors is formed on the photoconductive drum 1 while it rotates once.

Meanwhile, a recording medium is fed from the paper-feeding cassette 31 and carried to the resist rollers 35 by the first paper-feeding roller 32, the second paper-feeding rollers 33, and the conveying rollers 34. The resist rollers 35 feed the recording medium into the transfer area of the transfer belt 13 in synchronization with the movement of a color toner image being carried by the photoconductive drum 1. In the transfer area, the transfer roller 12 applies a bias voltage with polarity opposite to that of toner to the recording medium and thereby causes the color toner image to be transferred onto the recording medium.

After the color toner image is transferred onto the recording medium, the cleaning unit 14 removes toner remaining on the photoconductive drum 1. More specifically, the fur brush 16 first removes the remaining toner from the photoconductive drum 1, and then the cleaning blade 15 positioned downstream of the fur brush 16 removes any remaining toner. The removed toner is carried to a waste toner bottle (not shown) by the cleaning screw 17.

The recording medium with the color toner image is electrostatically attracted to the transfer belt 13 and is thereby carried to the drive roller 10. At the drive roller 10, the recording medium is separated from the transfer belt 13 by the curvature and carried to the fusing unit 18. At the fusing unit 18, the recording medium is pinched between and heated by the fusing belt 19 and the pressure roller 26 to fuse the color toner image. Then, the paper-ejecting roller 27 ejects the recording medium onto the paper catch tray 36.

In the case of duplex printing, the recording medium is carried to the reverse-feeding rollers 28 and is fed back to the resist rollers 35 by the reverse rotation of the reverse-feeding rollers 28. Then, the resist rollers 35 feed the recording medium into the transfer area of the transfer belt 13 in synchronization with the movement of another color toner image on the photoconductive drum 1. After the color toner image is transferred onto the back side of the recording medium, the recording medium goes through the fusing unit 18 again and is ejected onto the paper catch tray 36.

### First Embodiment

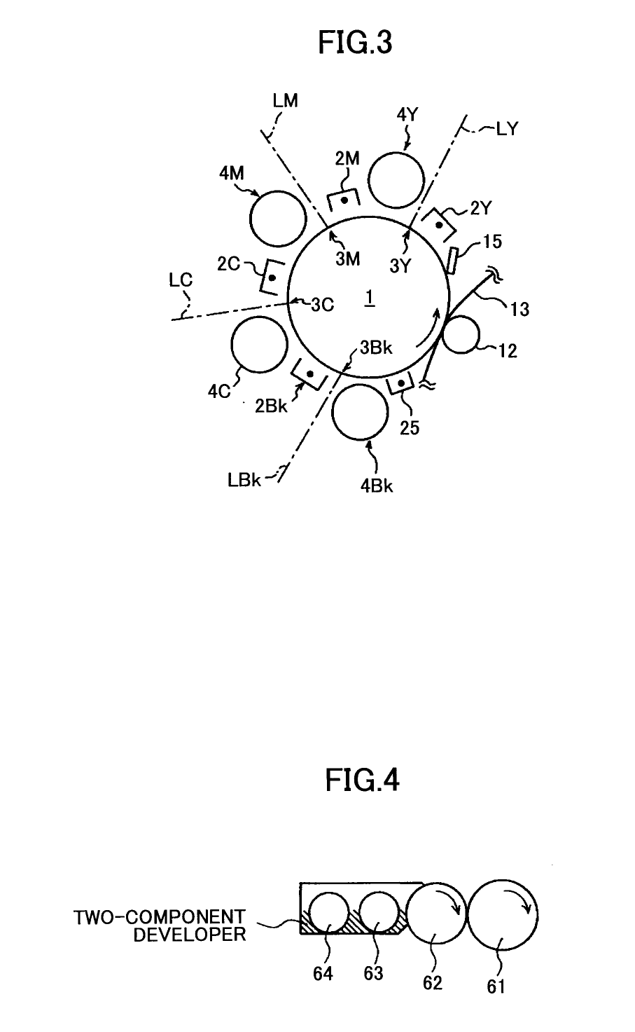

FIG. 3 is a schematic diagram of an imaging unit according to a first embodiment of the present invention. In this embodiment, the photoconductive drum 1 is positively-chargeable and has a photoconductive layer with a thickness of about 20 μm. The charging units 2Y, 2M, 2C, and 2Bk are implemented by direct-current (DC) scorotron chargers. Each of the exposing components 3Y, 3M, 3C, and 3Bk of the exposing unit 5 emits a laser beam L with a near-infrared wavelength of 780 nm that easily penetrates a toner layer. Basically, a laser beam having any wavelength greater than that of near-infrared rays may be used as the laser beam L. The developing units 4Y, 4M, 4C, and 4Bk develop without contact (with a developing gap of 150 μm) latent images by a one-component DC jumping development method. In the image-on-image development method, a toner image of a subsequent color is formed on a toner image of a preceding color. Therefore, in the image-on-image development method, noncontact developing units are used in order not to disturb a toner image of a preceding color. An AC jumping development method that uses an alternating electric field throughout a developing space between a developing roller and a photoconductive drum is not suitable for the image-on-image development method.

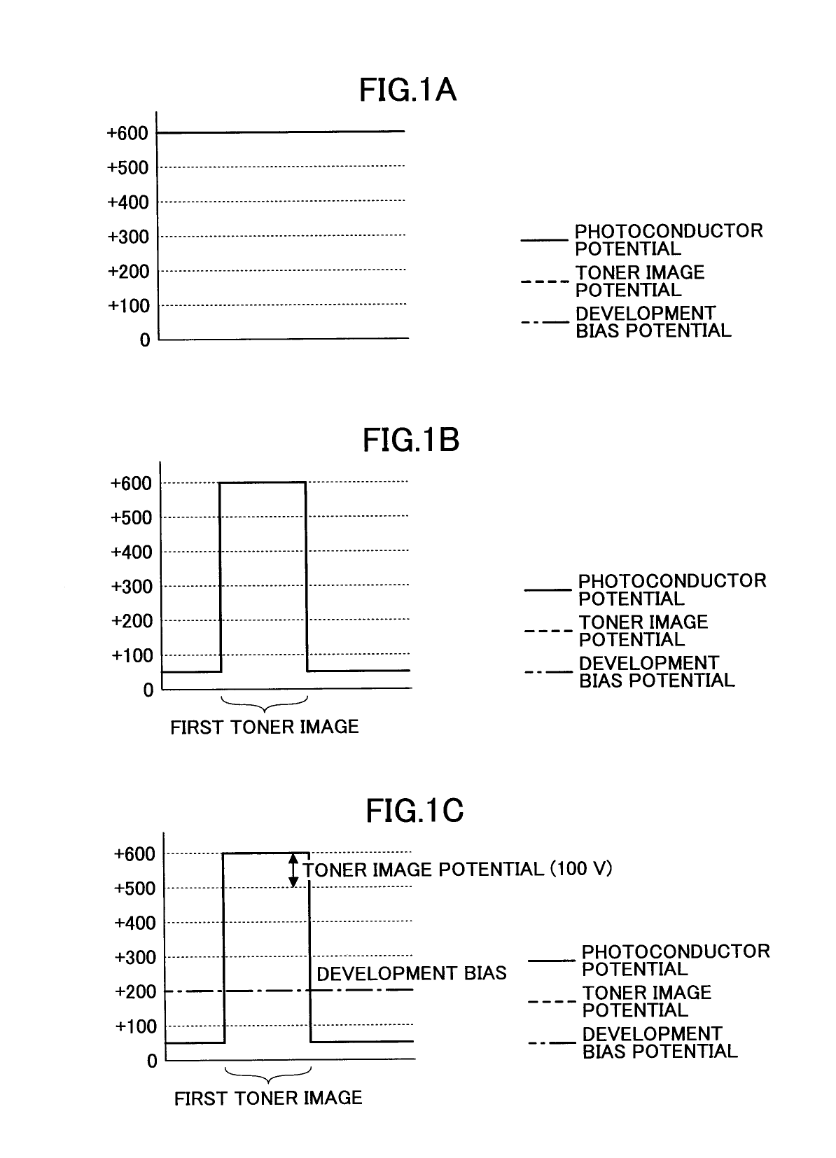

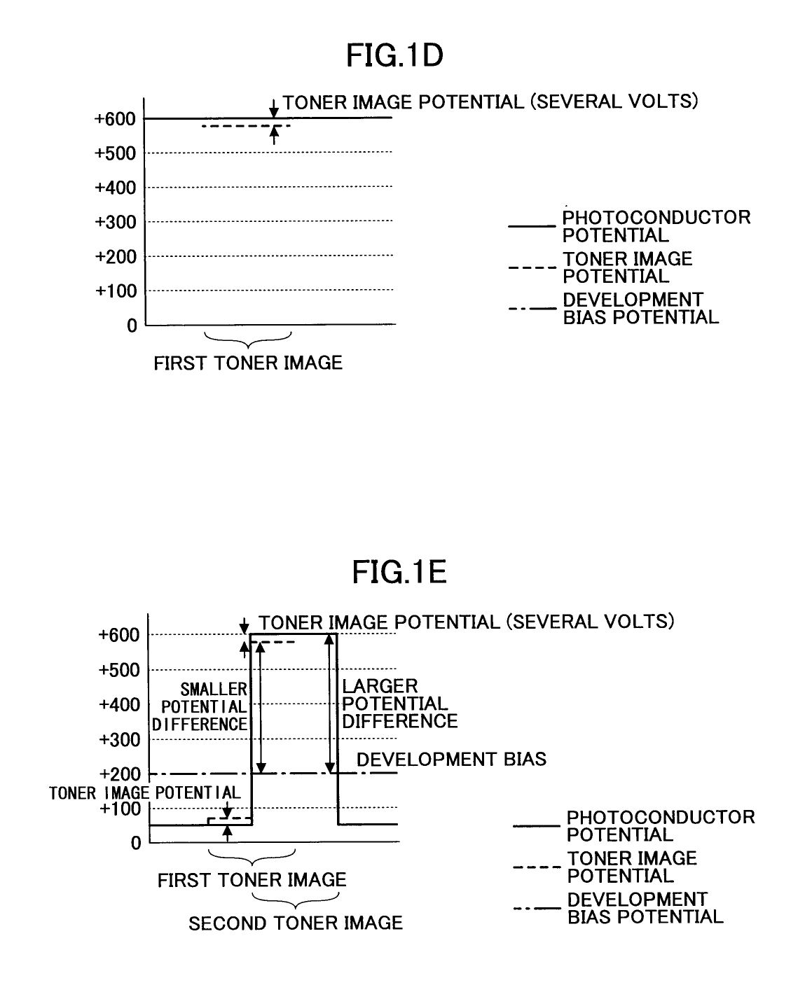

Next, an imaging process performed by the charging unit 2Y through the exposing component 3M is described with reference to FIGS. 1A through 1E.

First, the charging unit 2Y emits positive ions and thereby uniformly charges the photoconductive drum 1 to +600 V as shown in FIG. 1A in preparation for the formation of a latent image for a yellow toner image (a first toner image). Next, the exposing component 3Y exposes non-image areas on the photoconductive drum 1 as shown in FIG. 1B to form the latent image for the yellow toner image. “Non-image areas” indicate areas that do not constitute a toner image of a color to be formed. In other words, non-image areas are areas on the photoconductive drum 1 other than image areas (that constitute a latent image) where a toner image of a color is to be formed. Then, the developing unit 4Y develops the image areas (areas that have not been exposed; i.e. a latent image) with a negatively-charged toner having a charge amount of about −20 μC/g and a particle diameter of about 6 μm. The developing unit 4Y causes about 0.45 mg/cm² of the negatively-charged toner to adhere to the image areas using a development potential difference (difference between the potential of the image areas and a development bias potential) of about 400 V. Because of the potential (toner image potential) of the yellow toner image (toner layer) formed in the above step, the surface potential of the image areas apparently drops about 100 V as shown in FIG. 1C. Next, the charging unit 2M emits positive ions and thereby uniformly charges the photoconductive drum 1 again to +600 V in preparation for the formation of a latent image for a magenta toner image (a second toner image). When charged by the charging unit 2M, the surface potential of the non-image areas returns to +600 V, i.e., the same potential as that shown in FIG. 1A. At the same time, the yellow toner image (negatively-charged toner) on the image areas actively absorbs the positive ions and is thereby discharged. As a result, the charge amount of the yellow toner image (toner layer) is reduced to a range between about 0 μC/g and several μC/g, and the toner image potential is reduced to a range between about 0 V and several V. This in turn makes the surface potential of the photoconductive drum 1 substantially uniform as shown in FIG. 1D. Then, the exposing component 3M exposes non-image areas to form the latent image for the magenta toner image through the yellow toner image as shown in FIG. 1E.

Thus, in this embodiment, each of the charging units 2 recharges the photoconductive drum 1 where a preceding toner image is present, with ions having polarity opposite to that of toner. In other words, each of the charging units 2 discharges a toner layer and recharges the photoconductive drum 1 at the same time. This configuration makes it possible to make the development potential differences in a toner-image-present portion, where a preceding toner image is present, and a toner-image-absent portion, where a preceding toner image is not present, of a latent image substantially the same as shown in FIG. 1E. In other words, this configuration makes it possible to reduce the influence of the toner image potential of a preceding toner image on the formation of a subsequent toner image and thereby makes it possible to form the subsequent toner image with a uniform density.

Meanwhile, as described above, the charge amounts of yellow, magenta, and cyan toner images developed by the developing units 4Y, 4M, and 4C are reduced to a range between about 0 μC/g and several μC/g by the charging units 2M, 2C, and 2Bk. Therefore, it is difficult to electrostatically transfer the toner images onto a recording medium. In this embodiment, the charging unit 25 positively (or negatively) charges all of the toner images of four colors so that they can be transferred easily. The charging unit 25 is preferably implemented by a positive-ion-emitting corona charger or a negative-ion-emitting corona charger. Also, a noncontact charging roller or an ion-generating device may be used as the charging unit 25. Further, the charging unit 25 may be implemented by a contact charging unit such as a contact charging roller as long as it does not disturb toner images on the photoconductive drum 1.

In this embodiment, the charging units 2Y, 2M, 2C, and 2Bk are implemented by positive-ion-emitting corona chargers. Compared with negative-ion-emitting corona chargers, positive-ion-emitting corona chargers generate far less ozone and are therefore less harmful in terms of surface deterioration of the photoconductive drum 1 and disturbance of toner images in a high-humidity environment. Accordingly, using positive-ion-emitting corona chargers reduces the amount of ozone discharged from the charging units 2.

Although DC scorotron chargers are used in this embodiment as the charging units 2Y, 2M, 2C, and 2Bk, DC corotron chargers may be used instead.

Using DC corotron chargers may slightly reduce discharge stability and cause irregularity in image density. However, using DC corotron chargers simplifies configurations of charging units and therefore makes it possible to greatly reduce the production costs of an imaging unit. Also, using DC corotron chargers further reduces the amount of ozone discharged from the charging units 2.

Further, alternating current (AC) scorotron chargers or AC corotron chargers may be used as the charging units 2Y, 2M, 2C, and 2Bk.

When an imaging process is performed at a very high speed, when the particle diameter of toner is very small, or when the thickness of a toner layer is very large, it is sometimes difficult to discharge the entire toner layer with a DC discharge only. In such a case, superimposing an AC voltage makes it possible to uniformly discharge the entire toner layer.

### Second Embodiment

In a second embodiment of the present invention, a developing unit shown in FIG. 4 is used as each of the developing units 4Y, 4M, 4C, and 4Bk. As are the developing units 4 of the first embodiment, the developing units 4 of the second embodiment are noncontact developing units that do not disturb preceding toner images.

The developing units 4 of the second embodiment are described below in detail.

As shown in FIG. 4, the developing unit 4 of this embodiment includes a toner carrying roller 61, a mag roller 62, agitating screws 63 and 64, and a case containing the agitating screws 63 and 64 and two-component developer. Except for the toner carrying roller 61, the developing unit 4 has a configuration similar to that of a normal two-component developing unit. The two-component developer comprises magnetic carrier particles with a particle diameter of about 50 μm and toner with a particle diameter of about 6 μm. The weight percentage of toner in the two-component developer is about 6 wt %. The mag roller 62 includes a permanent magnet and carries the two-component developer to the toner carrying roller 61. A portion of the toner of the two-component developer is transferred to the toner carrying roller 61 by a bias potential applied to the toner. The transferred toner forms a “toner cloud” (toner floating above the toner carrying roller 61) on the toner carrying roller 61 by a mechanism described later, and is carried by the rotation of the toner carrying roller 61 to a developing zone facing the photoconductive drum 1. Because of the difference between the average potential of the surface of the toner carrying roller 61 and the potential of the photoconductive drum 1, the toner is transferred to the photoconductive drum 1 and forms a toner image. Unused toner remaining on the toner carrying roller 61 is transferred back to the mag roller 62. Since the toner is in the form of a toner cloud, adhesion of the toner to the toner carrying roller 61 is very weak. Therefore, the unused toner on the toner carrying roller 61 can be easily scraped or smoothed by the magnetic brush of the two-component developer on the mag roller 62. Through the above process, a substantially constant amount of toner is maintained in the form of a toner cloud on the toner carrying roller 61. Although a two-component developing method is used in this embodiment to supply toner to the toner carrying roller 61, other methods may also be used.

Details of the toner carrying roller 61 are described below. FIG. 5 is an enlarged view of the surface layers of the toner carrying roller 61. The surface layers include a base 65, aluminum-deposited electrodes 66 disposed at intervals on the base 65, and a resin coating 67 covering the base 65 and the electrodes 66. Other configurations may also be used for the surface layers of the toner carrying roller 61.

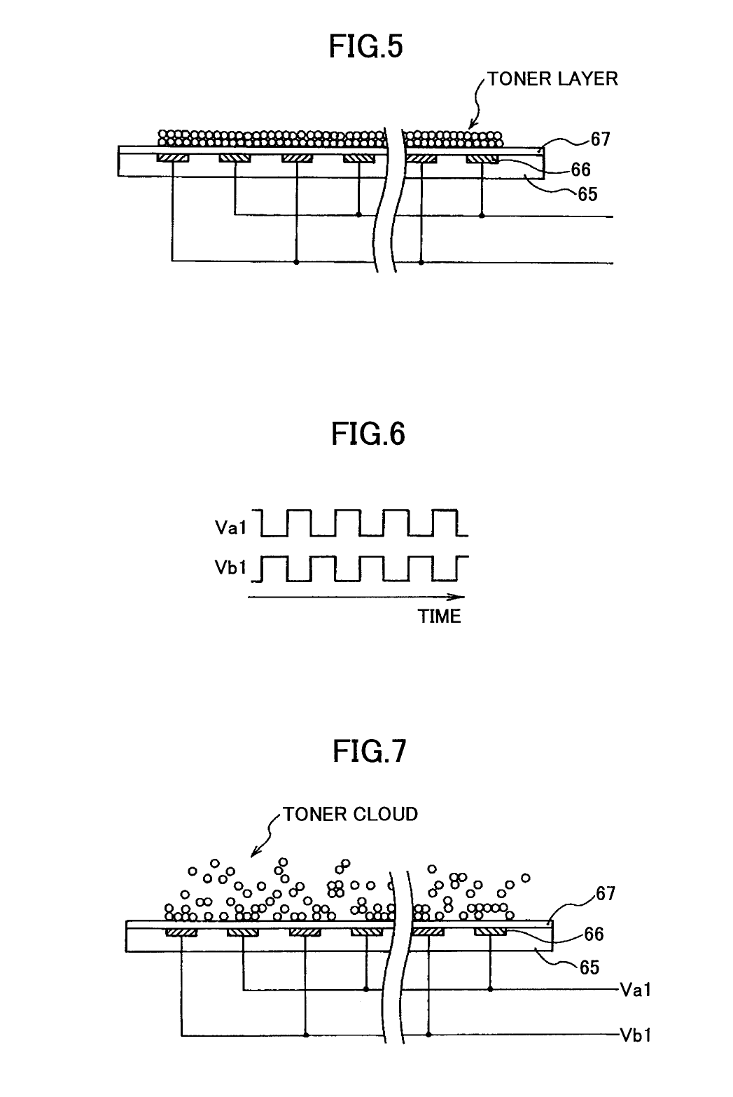

FIG. 7 is a drawing illustrating a toner cloud formed when voltages Va1 and Vb1 having different waveforms as shown in FIG. 6 are applied alternately to the electrodes 66 arranged at intervals as shown in FIG. 5. The positive and negative peaks of the voltages Va1 and Vb1 at a given timing are opposite to each other (there is a phase difference of 180 degrees) as shown in FIG. 6. Therefore, an oscillating electric field is formed between each pair of the electrodes 66, where to one of the pair the voltage Va1 is applied and to the other one of the pair the voltage Vb1 is applied. For descriptive purposes, the electrode 66 to which the voltage Va1 is applied is referred to as a Va1-applied electrode and the electrode 66 to which the voltage Vb1 is applied is referred to as a Vb1-applied electrode. The oscillating electric field causes toner on the toner carrying roller 61 to hop between the Va1-applied electrode and the Vb1-applied electrode and thereby to form a toner cloud (i.e., causes toner to float). With the above mechanism, the toner carrying roller 61 is able to carry toner in the form of a toner cloud.

In FIG. 6, each of the voltages Va1 and Vb1 is shown as an AC voltage with a rectangular wave. Alternatively, AC voltages with sine waves may be used as the voltages Va1 and Vb1. Thus, in this embodiment, electrodes of a toner carrying roller are arranged at intervals and categorized into two groups, and two voltages with different waveforms are applied to the respective groups. Alternatively, electrodes may be categorized into three or more groups and three or more voltages with different waveforms may be applied to the respective groups as long as an oscillating electric field is generated and a toner cloud is formed.

In this embodiment, a voltage including an AC component having a peak-to-peak voltage of 600 V and a rectangular wave with a frequency of 1 kHz, and a superimposed DC component of +200 V is used for each of the voltages Va1 and Vb1. A development bias, which causes toner to develop a latent image in the developing zone, is a time average of this voltage, i.e. +200 V. Compared with the one-component DC jumping development method used in the first embodiment, a toner-cloud development method described above makes it possible to develop a latent image with a substantially smaller development potential difference. That is, because toner is floating on the toner carrying roller 61 (in the form of a toner cloud) and its adhesion to the roller 61 is weak, it is possible to develop a latent image with a lower surface potential of the photoconductive drum 1. While the photoconductive drum 1 is charged to +600 V in the first embodiment, it is charged to +400 V in the second embodiment.

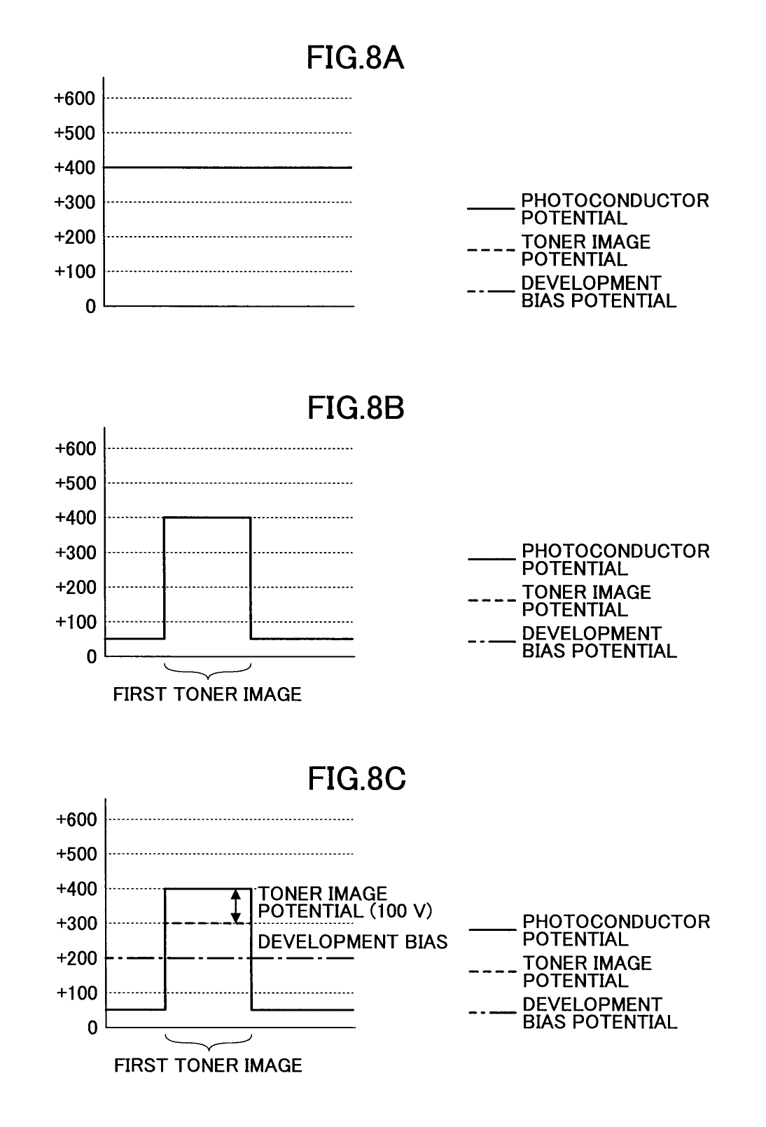

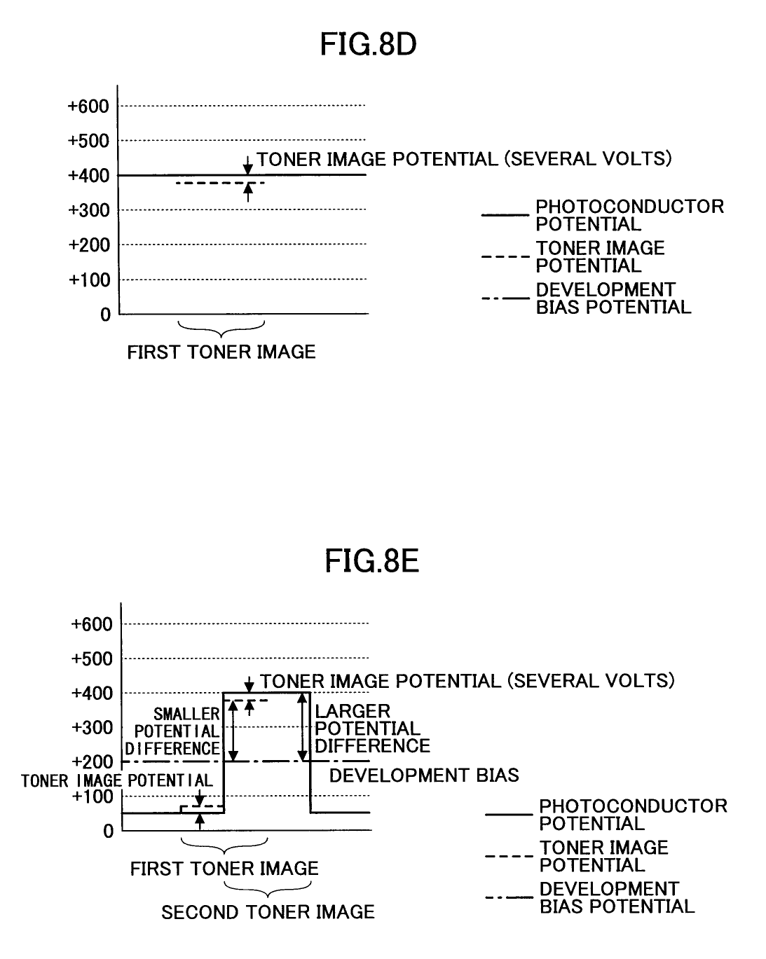

Next, an imaging process performed by the charging unit 2Y through the exposing component 3M is described with reference to FIGS. 8A through 8E.

First, the charging unit 2Y emits positive ions and thereby uniformly charges the photoconductive drum 1 to +400 V as shown in FIG. 8A in preparation for the formation of a latent image for a yellow toner image (a first toner image). Next, the exposing component 3Y exposes non-image areas on the photoconductive drum 1 as shown in FIG. 8B to form the latent image for the yellow toner image. Then, the developing unit 4Y develops image areas (areas that have not been exposed; i.e., a latent image) with a negatively-charged toner having a charge amount of about −22 μC/g and a particle diameter of about 6 μm. The developing unit 4Y causes about 0.4 mg/cm² of the negatively-charged toner to adhere to the image areas using a development potential difference of about 200 V. Because of the potential (toner image potential) of the yellow toner image (toner layer) formed in the above step, the surface potential of the image areas apparently drops about 100 V as shown in FIG. 8C. Next, the charging unit 2M emits positive ions and thereby uniformly charges the photoconductive drum 1 again to +400 V in preparation for the formation of a latent image for a magenta toner image (a second toner image). When charged by the charging unit 2M, the surface potential of the non-image areas returns to +400 V, i.e., the same potential as that shown in FIG. 8A. At the same time, the yellow toner image (negatively-charged toner) on the image areas actively absorbs the positive ions and is thereby discharged. As a result, the charge amount of the yellow toner image (toner layer) is reduced to a range between about 0 μC/g and several μC/g, and the toner image potential is reduced to a range between about 0 V and several V. This in turn makes the surface potential of the photoconductive drum 1 substantially uniform as shown in FIG. 8D. Then, the exposing component 3M exposes non-image areas to form the latent image for the magenta toner image through the yellow toner image as shown in FIG. 8E.

As is evident from FIGS. 8A through 8E, according to the second embodiment, where toner is caused to float on the toner carrying roller 61 (in the form of a tone cloud) and its adhesion to the roller 61 is weak, it is possible to develop a latent image with a lower surface potential of the photoconductive drum 1. Accordingly, the charging capability of the charging units 2 of the second embodiment can be made smaller than that in the first embodiment. Thus, the configuration of the second embodiment makes it possible to further reduce the amount of ozone generated and thereby to lengthen the service life of the photoconductive drum 1. Also, because there is no mechanically-driven part in the toner carrying roller 61, it is possible to reduce the size of the charging units 2Y, 2M, 2C, and 2Bk.

### Third Embodiment

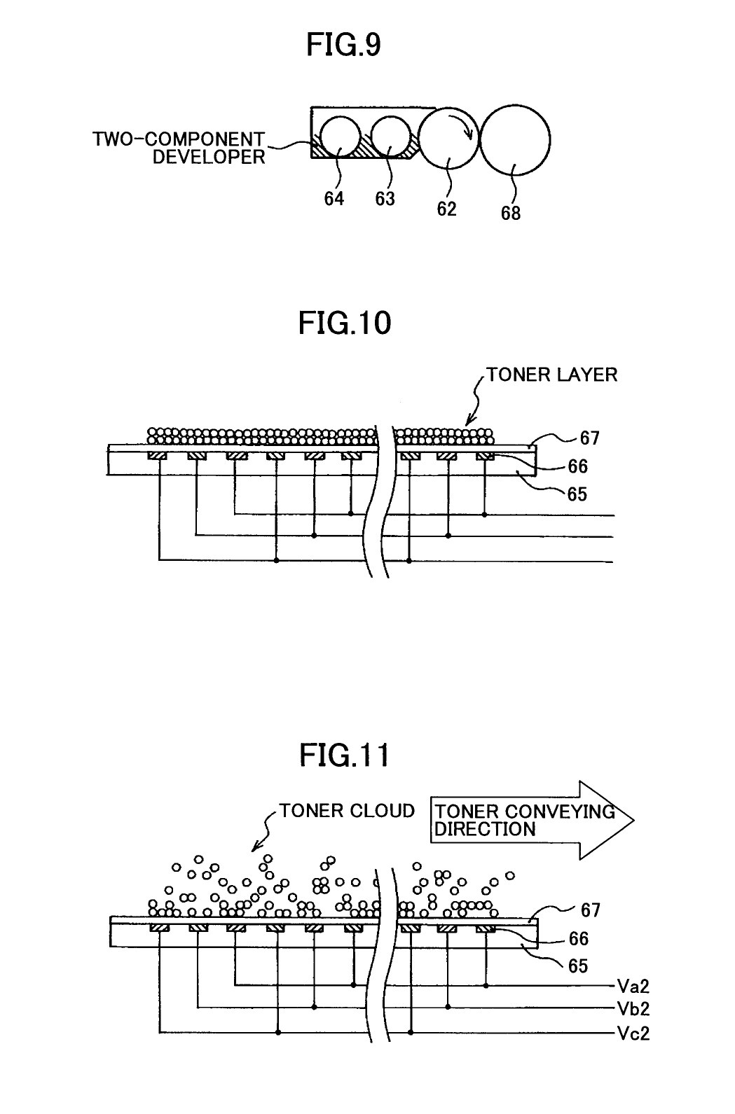

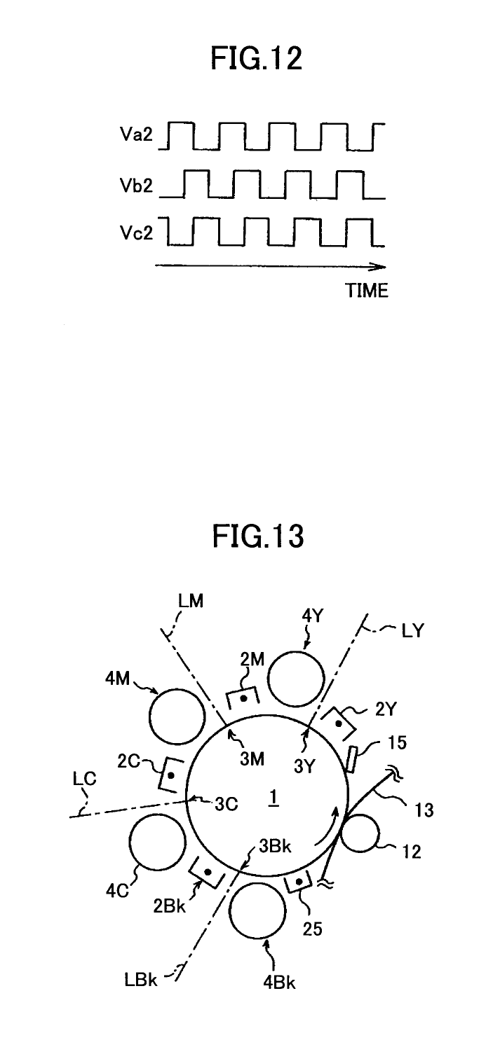

FIG. 9 is a schematic diagram of the developing unit 4 according to a third embodiment of the present invention. The developing unit 4 of the third embodiment has a configuration similar to that of the second embodiment. The developing unit 4 of the third embodiment is different from that of the second embodiment in that a toner carrying roller 68, which is not rotated, is provided instead of the toner carrying roller 61. In the toner carrying roller 68, the electrodes 66 are arranged at intervals and categorized into three groups (Va2-applied electrodes, Vb2-applied electrodes, and Vc2-applied electrodes) as shown in FIG. 10, and voltages Va2, Vb2, and Vc2 with different waveforms as shown in FIG. 12 are applied to the respective groups as shown in FIG. 11. As in the second embodiment, toner on the toner carrying roller 68 hops between the Va2-applied electrode and the Vb2-applied electrode and between the Vb2-applied electrode and the Vc2-applied electrode, and thereby forms a toner cloud. Also, as shown in FIG. 12, phases of the voltages Va2, Vb2, and Vc2 are shifted to generate a progressive-wave electric field that conveys toner. With the progressive-wave electric field, toner is repelled and attracted by the electrodes 66, and therefore hops between the electrodes 66 and moves in the direction (toner conveying direction) indicated by an arrow in FIG. 11. Thus, with the configuration of the third embodiment, it is possible to convey toner in the form of a toner cloud to the developing zone (a position facing the photoconductive drum 1) without mechanically rotating the toner carrying roller 68.

In this embodiment, each of the voltages Va2, Vb2, and Vc2 includes an AC component having a peak-to-peak voltage of 700 V and a rectangular wave with a frequency of 1.5 kHz, and a superimposed DC component of +200 V. A development bias, which causes toner to develop a latent image in the developing zone, is a time average of this voltage, i.e. +200 V. Compared with the one-component DC jumping development method used in the first embodiment, a toner-cloud development method described above makes it possible to develop a latent image with a substantially smaller development potential difference. Therefore, it is possible to develop a latent image with a lower surface potential of the photoconductive drum 1. In the third embodiment, the photoconductive drum 1 is charged to +400 V.

The exemplary imaging process described in the second embodiment with reference to FIGS. 8A through 8E may also be applied to the third embodiment. Accordingly, the charging capability of the charging units 2 of the third embodiment can be made smaller than that in the first embodiment. Thus, the configuration of the third embodiment makes it possible to further reduce the amount of ozone generated and thereby to lengthen the service life of the photoconductive drum 1. Also, because there is no need to mechanically-drive the toner carrying roller 68, it is possible to reduce the size of the charging units 2Y, 2M, 2C, and 2Bk.

### Fourth Embodiment

FIG. 13 is a schematic diagram of an imaging unit according to a fourth embodiment of the present invention. In the fourth embodiment, a photoconductive drum 11 is used instead of the photoconductive drum 1. The photoconductive drum 11 is negatively-chargeable and has a photoconductive layer with a thickness of about 20 μm. The charging units 2Y, 2M, 2C, and 2Bk are implemented by DC scorotron chargers. Each of the exposing components 3Y, 3M, 3C, and 3Bk of the exposing unit 5 emits a laser beam L with a near-infrared wavelength of 780 nm that easily penetrates a toner layer. Basically, a laser beam having any wavelength greater than that of near-infrared rays may be used as the laser beam L. The developing units 4Y, 4M, 4C, and 4Bk develop without contact (with a developing gap of 150 μm) latent images by a one-component DC jumping development method. In the image-on-image development method, a toner image of a subsequent color is formed on a toner image of a preceding color. Therefore, in the image-on-image development method, noncontact developing units are used in order not to disturb a toner image of a preceding color. An AC jumping development method that uses an alternating electric field throughout a developing space between a developing roller and a photoconductive drum is not suitable for the image-on-image development method. Other components and operations of the imaging unit of the fourth embodiment are substantially the same as those described in the first embodiment.

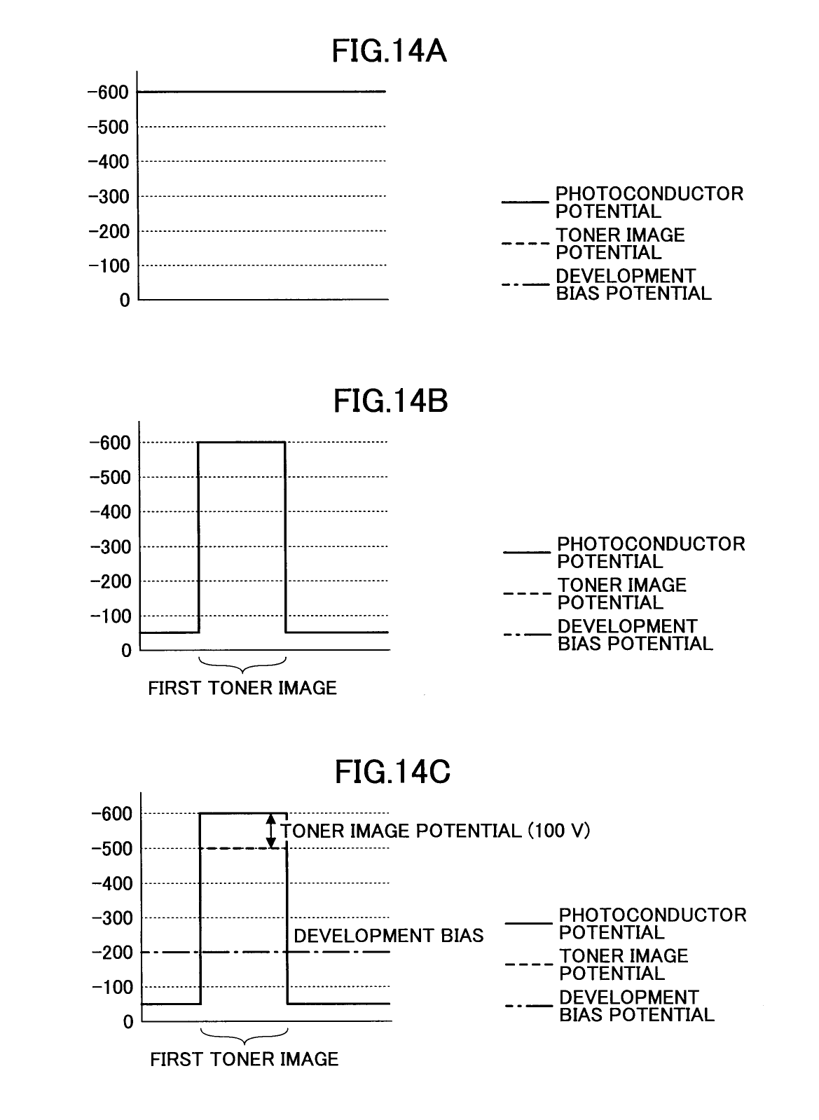

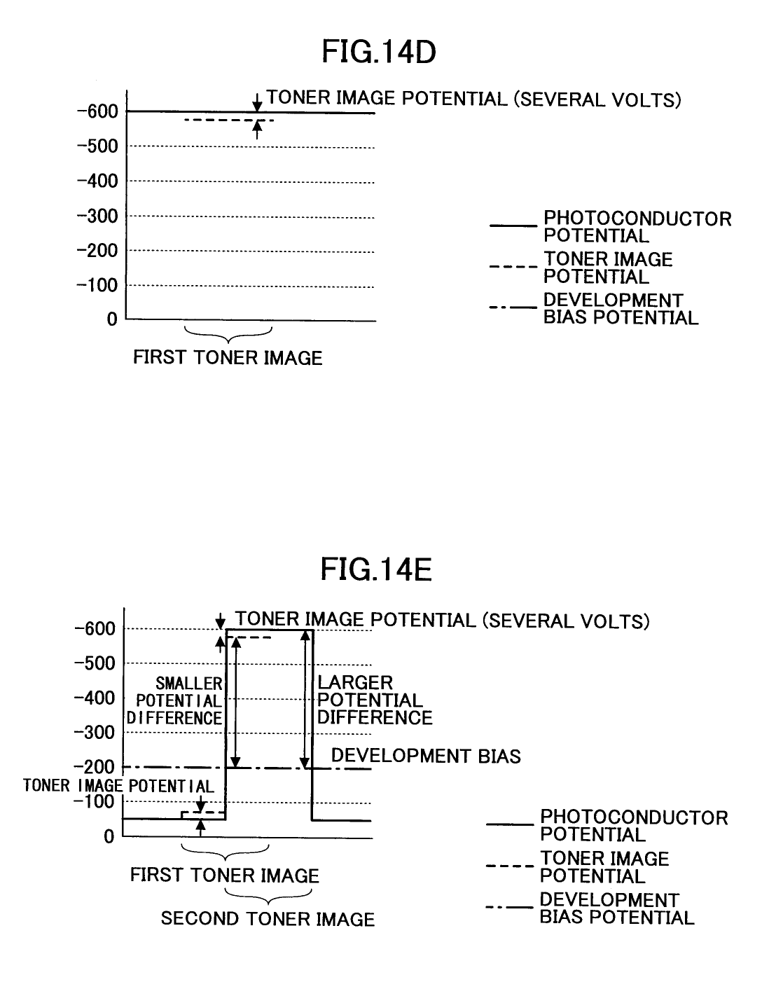

An imaging process performed by the charging unit 2Y through the exposing component 3M of this embodiment are described below with reference to FIGS. 14A through 14E.

First, the charging unit 2Y emits negative ions and thereby uniformly charges the photoconductive drum 11 to −600 V as shown in FIG. 14A in preparation for the formation of a latent image for a yellow toner image (a first toner image). Next, the exposing component 3Y exposes non-image areas on the photoconductive drum 11 as shown in FIG. 14B to form the latent image for the yellow toner image. Then, the developing unit 4Y develops image areas (areas that have not been exposed; i.e. a latent image) with a positively-charged toner having a charge amount of about +20 μC/g and a particle diameter of about 6 μm. The developing unit 4Y causes about 0.45 mg/cm² of the positively-charged toner to adhere to the image areas using a development potential difference of about 400 V. Because of the potential (toner image potential) of the yellow toner image (toner layer) formed in the above step, the surface potential of the image areas apparently drops about 100 V as shown in FIG. 14C. Next, the charging unit 2M emits negative ions and thereby uniformly charges the photoconductive drum 11 again to −600 V in preparation for the formation of a latent image for a magenta toner image (a second toner image). When charged by the charging unit 2M, the surface potential of the non-image areas returns to −600 V, i.e., the same potential as that shown in FIG. 14A. At the same time, the yellow toner image (positively-charged toner) on the image areas actively absorbs the negative ions and is thereby discharged. As a result, the charge amount of the yellow toner image (toner layer) is reduced to a range between about 0 μC/g and several μC/g, and the toner image potential is reduced to a range between about 0 V and several V. This in turn makes the surface potential of the photoconductive drum 11 substantially uniform as shown in FIG. 14D. Then, the exposing component 3M exposes non-image areas to form the latent image for the magenta toner image through the yellow toner image as shown in FIG. 14E.

Thus, in this embodiment, each of the charging units 2 recharges the photoconductive drum 11 where a preceding toner image is present, with ions having polarity opposite to that of toner. In other words, each of the charging units 2 discharges a toner layer and recharges the photoconductive drum 11 at the same time. This configuration makes it possible to make the development potential differences in a toner-image-present portion, where a preceding toner image is present, and a toner-image-absent portion, where a preceding toner image is not present, of a latent image substantially the same as shown in FIG. 14E. In other words, this configuration makes it possible to reduce the influence of the toner image potential of a preceding toner image on the formation of a subsequent toner image and thereby makes it possible to form the subsequent toner image with a uniform density.

Meanwhile, as described above, the charge amounts of yellow, magenta, and cyan toner images developed by the developing units 4Y, 4M, and 4C are reduced to a range between about 0 μC/g and several μC/g by the charging units 2M, 2C, and 2Bk. Therefore, it is difficult to electrostatically transfer the toner images onto a recording medium. In this embodiment, the charging unit 25 positively (or negatively) charges all of the toner images of four colors so that they can be transferred easily.

Although DC scorotron chargers are used in this embodiment as the charging units 2Y, 2M, 2C, and 2Bk, DC corotron chargers may be used instead.

Using DC corotron chargers may slightly reduce discharge stability and cause irregularity in image density. However, using DC corotron chargers simplifies configurations of charging units and therefore makes it possible to greatly reduce the production costs of an imaging unit. Also, using DC corotron chargers further reduces the amount of ozone discharged from the charging units 2.

Further, AC scorotron chargers or AC corotron chargers may be used as the charging units 2Y, 2M, 2C, and 2Bk.

When an imaging process is performed at a very high speed, when the particle diameter of toner is very small, or when the thickness of a toner layer is very large, it is sometimes difficult to discharge the entire toner layer with a DC discharge only. In such a case, superimposing an AC makes it possible to uniformly discharge the entire toner layer.

### Fifth Embodiment

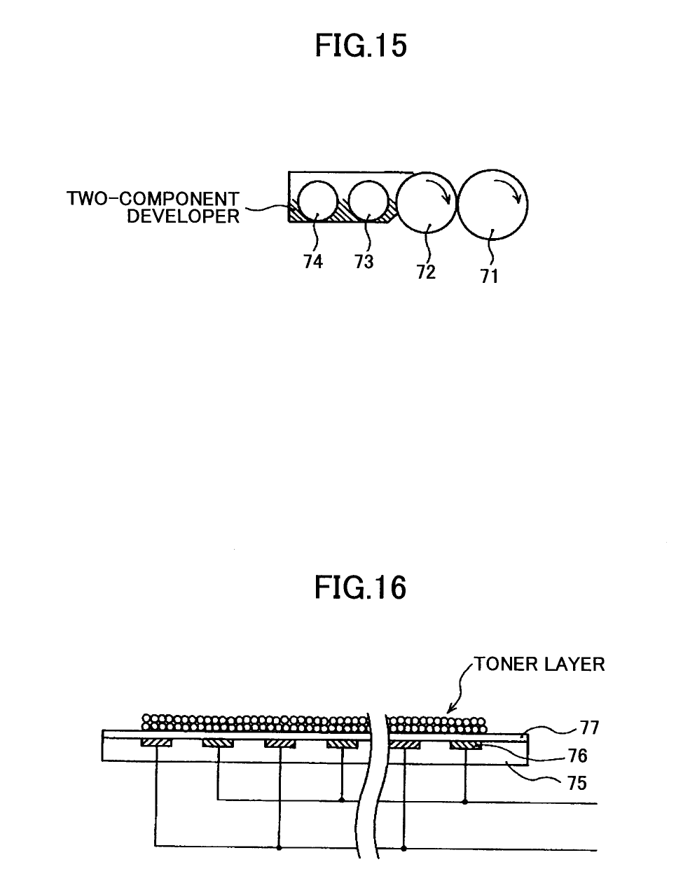

In a fifth embodiment of the present invention, a developing unit shown in FIG. 15 is used as each of the developing units 4Y, 4M, 4C, and 4Bk. Other components and operations of the imaging unit of the fifth embodiment are substantially the same as those described in the fourth embodiment. As are the developing units 4 of the fourth embodiment, the developing units 4 of the fifth embodiment are noncontact developing units that do not disturb preceding toner images.

The developing units 4 of the fifth embodiment are described below in detail.

As shown in FIG. 15, the developing unit 4 of this embodiment includes a toner carrying roller 71, a mag roller 72, agitating screws 73 and 74, and a case containing the agitating screws 73 and 74 and two-component developer. Except for the toner carrying roller 71, the developing unit 4 has a configuration similar to that of a normal two-component developing unit. The two-component developer comprises magnetic carrier particles with a particle diameter of about 50 μm and toner with a particle diameter of about 6 μm. The weight percentage of toner in the two-component developer is about 6 wt %. The mag roller 72 includes a permanent magnet and carries the two-component developer to the toner carrying roller 71. A portion of the toner of the two-component developer is transferred to the toner carrying roller 71 by a bias potential applied to the toner. The transferred toner forms a “toner cloud” (toner floating above the toner carrying roller 71) on the toner carrying roller 71, and is carried by the rotation of the toner carrying roller 71 to a developing zone facing the photoconductive drum 11. Because of the difference between the average potential of the surface of the toner carrying roller 71 and the potential of the photoconductive drum 11, the toner is transferred to the photoconductive drum 11 and forms a toner image. Unused toner remaining on the toner carrying roller 71 is transferred back to the mag roller 72. Because the toner is in the form of a toner cloud, the adhesion of the toner to the toner carrying roller 71 is very weak. Therefore, the unused toner on the toner carrying roller 71 can be easily scraped or smoothed by the magnetic brush of the two-component developer on the mag roller 62. Through the above process, a substantially constant amount of toner is maintained in the form of a toner cloud on the toner carrying roller 71. Although a two-component developing method is used in this embodiment to supply toner to the toner carrying roller 71, other methods may also be used.

Details of the toner carrying roller 71 are described below. FIG. 16 is an enlarged view of the surface layers of the toner carrying roller 71. The surface layers include a base 75, aluminum-deposited electrodes 76 disposed at intervals on the base 75, and a resin coating 77 covering the base 75 and the electrodes 76. Other configurations may also be used for the surface layers of the toner carrying roller 71.

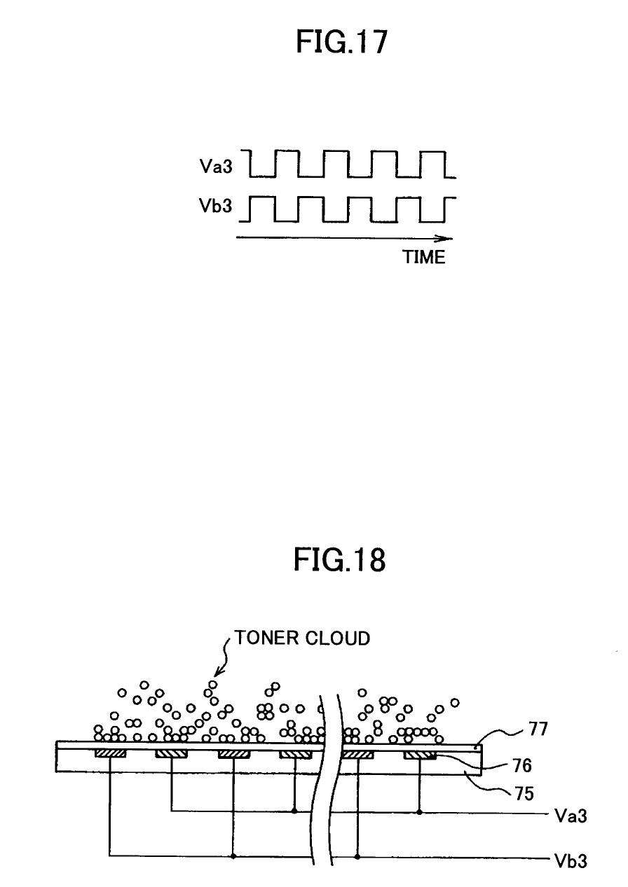

FIG. 18 is a drawing illustrating a toner cloud formed when voltages Va3 and Vb3 having different waveforms as shown in FIG. 17 are applied alternately to the electrodes 76 arranged at intervals as shown in FIG. 16. The positive and negative peaks of the voltages Va3 and Vb3 at a given timing are opposite to each other (there is a phase difference of 180 degrees) as shown in FIG. 17. Therefore, an oscillating electric field is formed between each pair of the electrodes 76, where to one of the pair the voltage Va3 is applied and to the other one of the pair the voltage Vb3 is applied. For descriptive purposes, the electrode 76 to which the voltage Va3 is applied is referred to as a Va3-applied electrode and the electrode 76 to which the voltage Vb3 is applied is referred to as a Vb3-applied electrode. The oscillating electric field causes toner on the toner carrying roller 71 to hop between the Va3-applied electrode and the Vb3-applied electrode and thereby to form a toner cloud (i.e., causes toner to float). With the above mechanism, the toner carrying roller 71 is able to carry toner in the form of a toner cloud. In FIG. 17, each of the voltages Va3 and Vb3 is shown as an AC voltage with a rectangular wave. Alternatively, AC voltages with sine waves may be used as the voltages Va3 and Vb3. Thus, in this embodiment, electrodes of a toner carrying roller are arranged at intervals and categorized into two groups, and two voltages with different waveforms are applied to the respective groups. Alternatively, electrodes may be categorized into three or more groups and three or more voltages with different waveforms may be applied to the respective groups as long as an oscillating electric field is generated and a toner cloud is formed.

In this embodiment, a voltage including an AC component having a peak-to-peak voltage of 600 V and a rectangular wave with a frequency of 1 kHz, and a superimposed DC component of −200 V is used for each of the voltages Va3 and Vb3. A development bias, which causes toner to develop a latent image in the developing zone, is a time average of this voltage, i.e. −200 V. Compared with the one-component DC jumping development method used in the fourth embodiment, a toner-cloud development method described above makes it possible to develop a latent image with a substantially smaller development potential difference. While the photoconductive drum 11 is charged to −600 V in the fourth embodiment, it is charged to −400 V in the fifth embodiment.

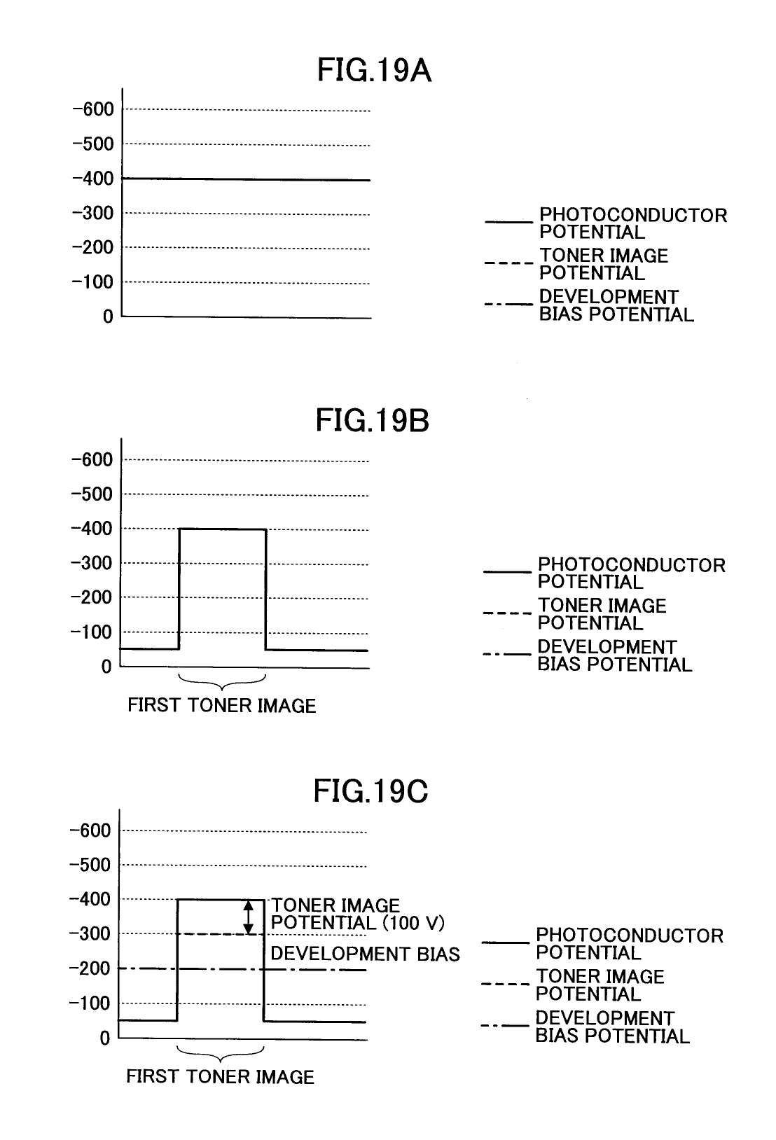

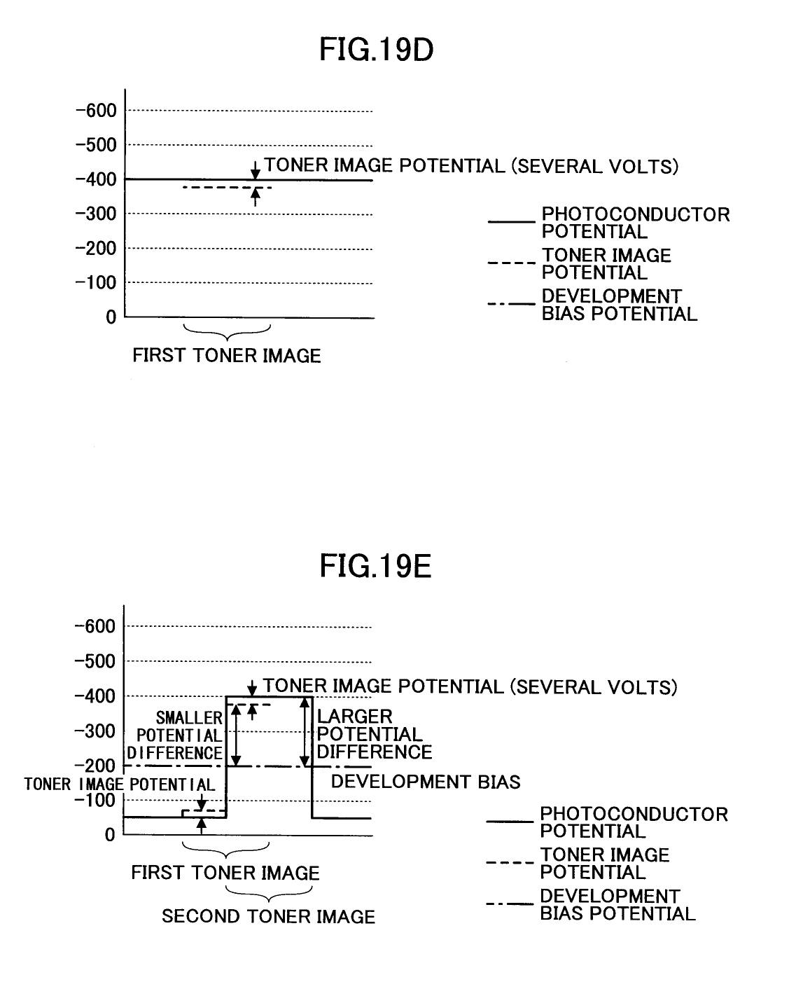

Next, an imaging process performed by the charging unit 2Y through the exposing component 3M is described with reference to FIGS. 19A through 19E.

First, the charging unit 2Y emits negative ions and thereby uniformly charges the photoconductive drum 11 to −400 V as shown in FIG. 19A in preparation for the formation of a latent image for a yellow toner image (a first toner image). Next, the exposing component 3Y exposes non-image areas on the photoconductive drum 11 as shown in FIG. 19B to form the latent image for the yellow toner image. Then, the developing unit 4Y develops image areas (areas that have not been exposed; i.e. a latent image) with a positively-charged toner having a charge amount of about +22 μC/g and a particle diameter of about 6 μm. The developing unit 4Y causes about 0.4 mg/cm² of the positively-charged toner to adhere to the image areas using a development potential difference of about 200 V. Because of the potential (toner image potential) of the yellow toner image (toner layer) formed in the above step, the surface potential of the image areas drops about 100 V as shown in FIG. 19C. Next, the charging unit 2M emits negative ions and thereby uniformly charges the photoconductive drum 11 again to −400 V in preparation for the formation of a latent image for a magenta toner image (a second toner image). When charged by the charging unit 2M, the surface potential of the non-image areas returns to −400 V, i.e., the same potential as that shown in FIG. 19A. At the same time, the yellow toner image (positively-charged toner) on the image areas actively absorbs the negative ions and is thereby discharged. As a result, the charge amount of the yellow toner image (toner layer) is reduced to a range between about 0 μC/g and several μC/g, and the toner image potential is reduced to a range between about 0 V and several V. This in turn makes the surface potential of the photoconductive drum 11 substantially uniform as shown in FIG. 19D. Then, the exposing component 3M exposes non-image areas to form the latent image for the magenta toner image through the yellow toner image as shown in FIG. 19E.

As is evident from FIGS. 19A through 19E, according to the fifth embodiment, where toner is caused to float on the toner carrying roller 71 (in the form of a tone cloud) and its adhesion to the roller 71 is weak, it is possible to develop a latent image with a lower surface potential of the photoconductive drum 11. Accordingly, the charging capability of the charging units 2 of the fifth embodiment can be made smaller than that in the fourth embodiment. Thus, the configuration of the fifth embodiment makes it possible to further reduce the amount of ozone generated and thereby to lengthen the service life of the photoconductive drum 11. Also, because there is no mechanically-driven part in the toner carrying roller 71, it is possible to reduce the size of the charging units 2Y, 2M, 2C, and 2Bk.

### Sixth Embodiment

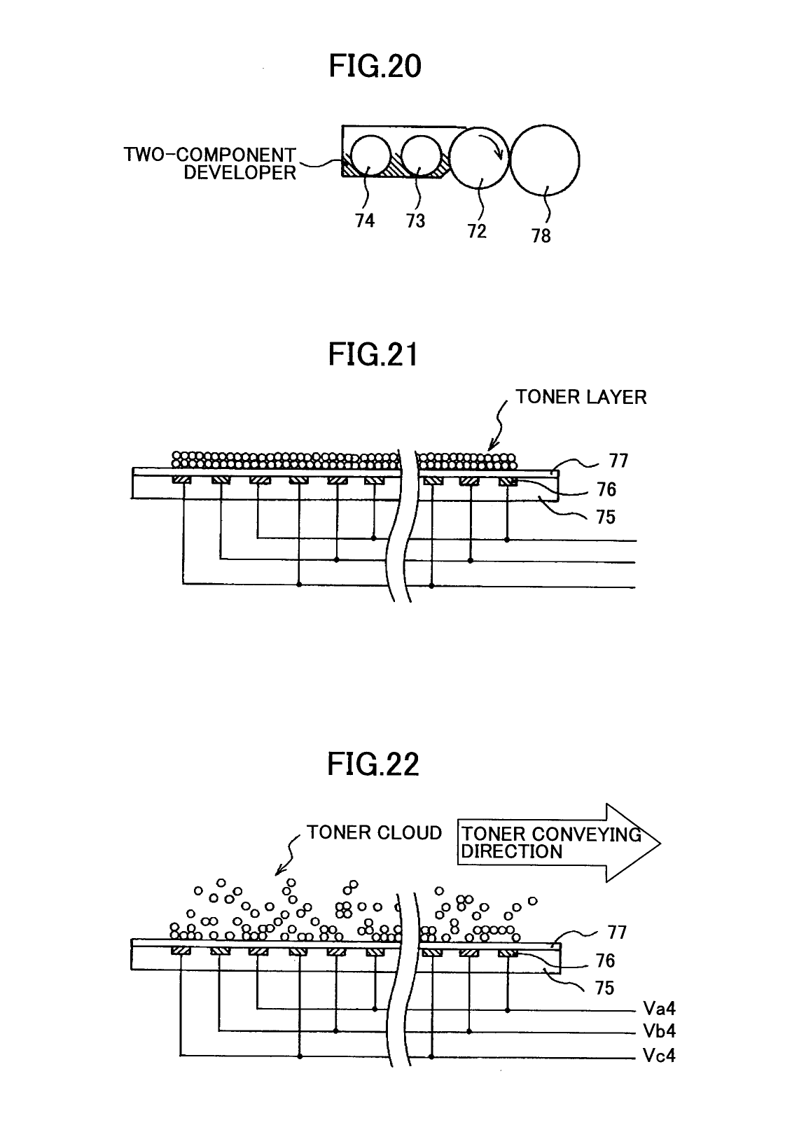

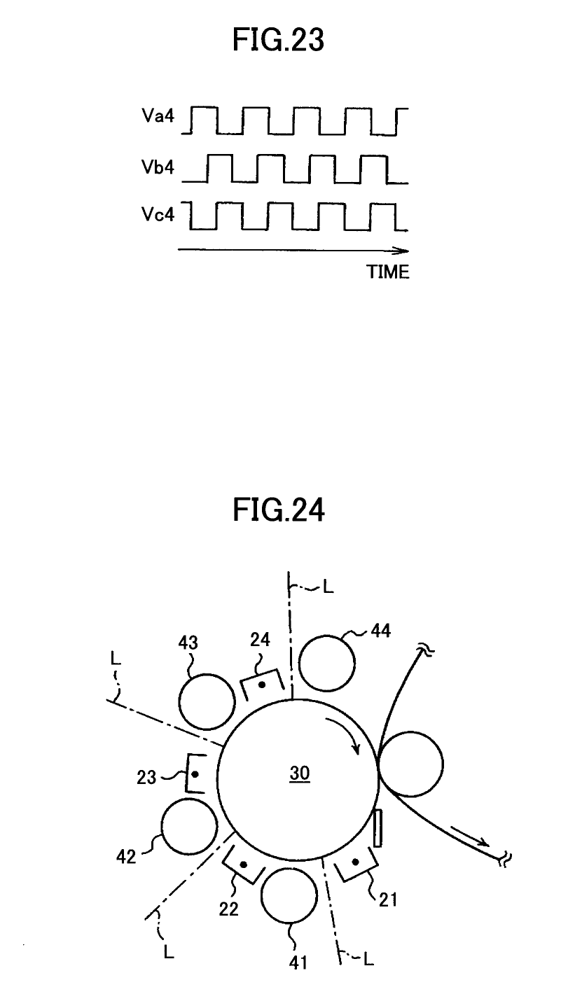

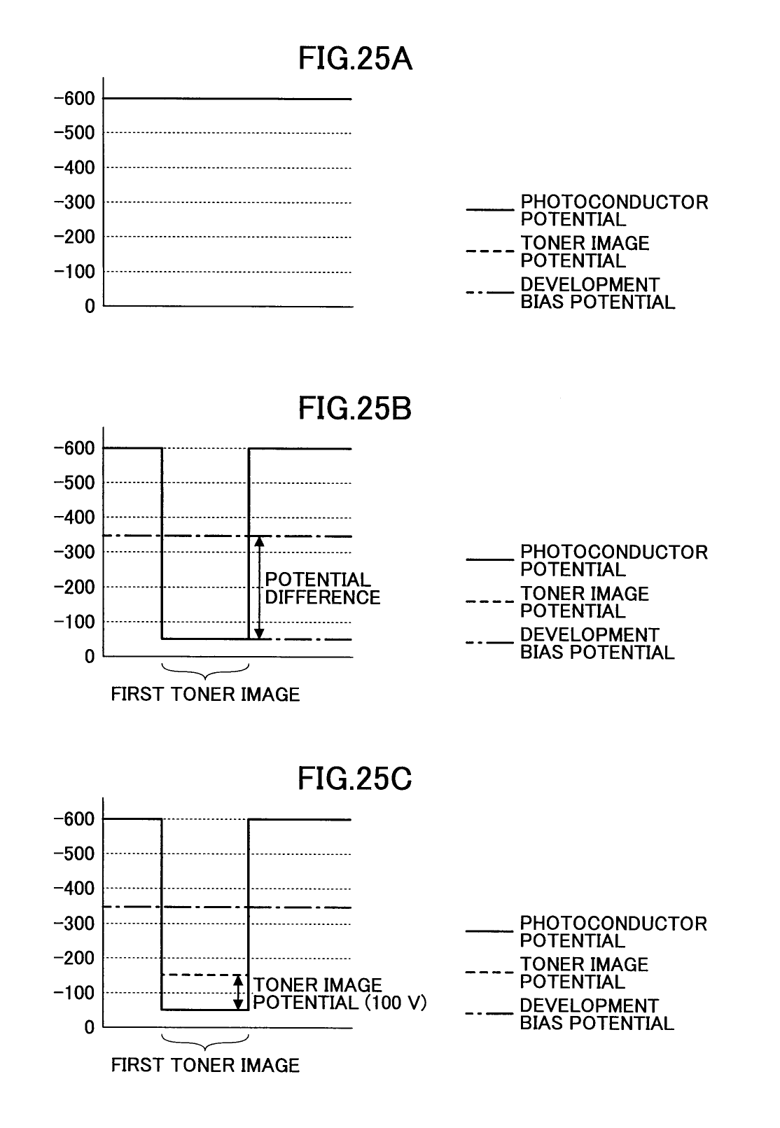

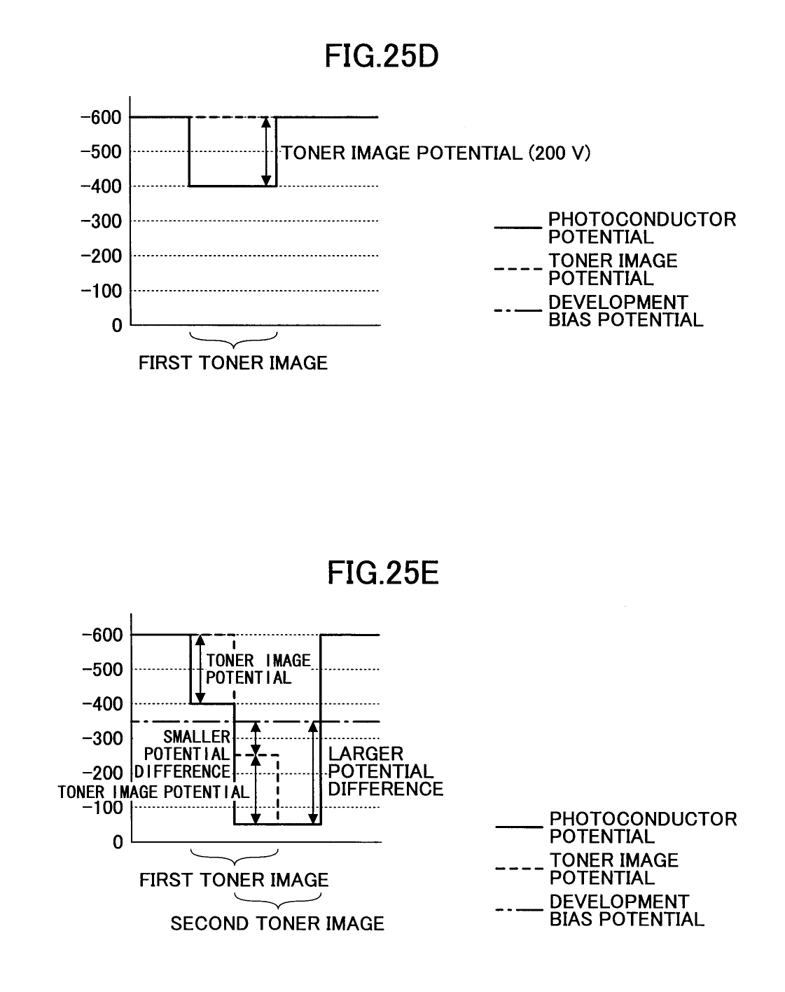

FIG. 20 is a schematic diagram of the developing unit 4 according to a sixth embodiment of the present invention. The developing unit 4 of the sixth embodiment has a configuration similar to that of the fifth embodiment. The developing unit 5 of the sixth embodiment is different from that of the fifth embodiment in that a toner carrying roller 78, which is not rotated, is provided instead of the toner carrying roller 71. In the toner carrying roller 78, the electrodes 76 are arranged at intervals and categorized into three groups (Va4-applied electrodes, Vb4-applied electrodes, and Vc4-applied electrodes) as shown in FIG. 21, and voltages Va4, Vb4, and Vc4 with different waveforms as shown in FIG. 23 are applied to the respective groups as shown in FIG. 22. As in the fifth embodiment, toner on the toner carrying roller 78 hops between the Va4-applied electrode and the Vb4-applied electrode and between the Vb4-applied electrode and the Vc4-applied electrode, and thereby forms a toner cloud. Also, as shown in FIG. 23, phases of the voltages Va4, Vb4, and Vc4 are shifted to form a progressive-wave electric field that conveys toner. With the progressive-wave electric field, toner is repelled and attracted by the electrodes 76, and therefore hops between the electrodes 76 and moves in the direction (toner conveying direction) indicated by an arrow in FIG. 22. Thus, with the configuration of the sixth embodiment, it is possible to convey toner in the form of a toner cloud to the developing zone (a position facing the photoconductive drum 11) without mechanically rotating the toner carrying roller 78.

In this embodiment, each of the voltages Va4, Vb4, and Vc4 includes an AC component having a peak-to-peak voltage of 700 V and a rectangular wave with a frequency of 1.5 kHz, and a superimposed DC component of −200 V. A development bias voltage, which causes toner to develop a latent image in the developing zone, is a time average of this voltage, i.e. −200 V. Compared with the one-component DC jumping development method used in the fourth embodiment, a toner-cloud development method described above makes it possible to develop a latent image with a substantially smaller development potential difference. Therefore, it is possible to develop a latent image with a lower surface potential of the photoconductive drum 11. In the sixth embodiment, the photoconductive drum 11 is charged to −400 V.

The exemplary imaging process described in the fifth embodiment with reference to FIGS. 19A through 19E may also be applied to the sixth embodiment. Accordingly, the charging capability of the charging units 2 of the sixth embodiment can be made smaller than that in the fourth embodiment. Thus, the configuration of the sixth embodiment makes it possible to further reduce the amount of ozone generated and thereby to lengthen the service life of the photoconductive drum 11. Also, because there is no need to mechanically drive the toner carrying roller 78, it is possible to reduce the size of the charging units 2Y, 2M, 2C, and 2Bk.

As described above, according to embodiments of the present invention, the printer 100 as an example of an image forming apparatus includes the photoconductive drum 1, 11 used as an image carrier, the charging units 2Y, 2M, 2C, and 2Bk that charge the photoconductive drum 1, 11, the exposing unit 5 that forms latent images for toner images of different colors by exposing the charged photoconductive drum 1, 11, and the developing units 4Y, 4M, 4C, and 4Bk that develop the formed latent images with toners of the corresponding colors. The charging units 2, the exposing unit 5, and the developing units 4 form toner images of different colors one by one on the same photoconductive drum 1, 11, and thereby form a color toner image. More specifically, the exposing unit 5 exposes non-image areas on the photoconductive drum 1, 11 charged by the charging units 2Y, 2M, 2C, and 2Bk to form latent images for toner images of different colors; and the developing units 4Y, 4M, 4C, and 4Bk develop the latent images with toners of the respective colors having polarity opposite to the charge polarity of the photoconductive drum 1, 11. With this configuration, the toner image potential of a preceding toner image is offset, before a latent image for a subsequent toner image is formed, by ions emitted from the charging unit 2Y, 2M, 2C, or 2Bk and having the same polarity as the charge polarity of the photoconductive drum 1, 11. Thus, this configuration makes it possible to make the development potential differences in a toner-image-present portion, where a preceding toner image is present, and a toner-image-absent portion, where a preceding toner image is not present, of a latent image substantially the same. In other words, this configuration makes it possible for each of the charging units 2 to discharge a preceding toner image and recharge the photoconductive drum 1, 11 at the same time before a latent image for a subsequent toner image is formed, and thereby makes it possible to form the subsequent toner image with a uniform density. Further, this configuration eliminates the need to provide a dedicated discharging unit to discharge a preceding toner image and therefore makes it possible to reduce the size of an image forming apparatus.

According to embodiments of the present invention, each of the charging units 2 and the corresponding one of the developing units 4 form an image forming unit, and multiple image forming units are arranged around the photoconductive drum 1, 11. In each image forming unit, the developing unit 4 is disposed downstream of the charging unit 2 with respect to the rotational direction (or the movement direction of the surface) of the photoconductive drum 1, 11. This configuration makes it possible to form a color toner image on the photoconductive drum 1, 11 while the photoconductive drum 1, 11 rotates once, and thereby makes it possible to reduce the time for image formation.

According to the first through third embodiments, the photoconductive drum 1 is positively charged and toner is negatively charged. This configuration makes it possible to use positive-ion-emitting corona chargers as the charging units 2. Compared with negative-ion-emitting corona chargers, positive-ion-emitting corona chargers generate far less ozone and are therefore less harmful in terms of surface deterioration of the photoconductive drum 1 and disturbance of toner images in a high-humidity environment. Accordingly, using positive-ion-emitting corona chargers reduces the amount of ozone discharged from the charging units 2.

According to the fourth through sixth embodiments, the photoconductive drum 11 is negatively charged and toner is positively charged. This configuration makes it possible to use negatively-chargeable photoconductors that are normally cheaper and available in a wider variety than positively chargeable photoconductors.

According to embodiments of the present invention, the charging units 2 are configured to charge without contact the photoconductive drum 1, 11 and toner images. Therefore, the charging units 2 can charge the photoconductive drum 1, 11 and toner images thereon without disturbing the toner images.

According to embodiments of the present invention, the printer 100 includes a power-supply unit that supplies, for example, a DC voltage to the charging units 2. With a DC voltage, the charging units 2 are able to constantly emit ions with the same polarity and thereby to charge the photoconductive drum 1, 11 at a high linear velocity. Therefore, using a DC voltage also makes it possible to use small chargers as the charging units 2.

According to embodiments of the present invention, the developing unit 4 includes the toner carrying roller 61, 68, 71, 78 used as a toner carrier. The toner carrying roller 61, 68, 71, 78 includes the electrodes 66, 76 formed on the surface of the toner carrying roller 61, 68, 71, 78 and insulated from each other. The electrodes 66, 76 are categorized into two or more groups and voltages having a predetermined phase difference therebetween are applied to the respective groups. The electrodes 66, 76 thereby function as a hopping electric field generating unit that causes toner to hop between the electrodes 66, 76 and thereby to float above the toner carrying roller 61, 68, 71, 78 as a “toner cloud”. Because toner is held on the toner carrying roller 61, 68, 71, 78 as a toner cloud, its adhesion to the toner carrying roller 61, 68, 71, 78 is very weak. This makes it possible to develop without contact a latent image with a small development potential difference (difference between the potential of image areas and a development bias potential). In other words, the above configuration makes it possible to develop a latent image with a lower surface potential of the photoconductive drum 1, 11, to use small chargers with a lower charging capability as the charging units 2, and thereby to reduce the size of an imaging unit.

According to embodiments of the present invention, the toner carrying roller 61, 71 carries toner by the movement of its surface to the developing zone.

According to embodiments of the present invention, the hopping electric field generating unit generates a progressive-wave electric field that causes toner on the toner carrying roller 68, 78 to hop between the electrodes 66, 76 and to move to the developing zone. This configuration makes it possible to convey toner on the toner carrying roller 68, 78 to the developing zone without rotating the toner carrying roller 68, 78. Because there is no need to provide a drive unit for rotating the toner carrying roller 68, 78, this configuration makes it possible to reduce the size of an image forming apparatus.

An embodiment of the present invention provides a process cartridge attachable and detachable to and from the printer 100. The process cartridge includes the photoconductive drum 1, 11, the charging units 2, the developing units 4, and the cleaning unit 14.

Although noncontact charging units are used as the charging units 2 and 25 in the above embodiments, contact charging units such as contact charging rollers may be used as long as they do not disturb toner images on the photosensitive drum 1, 11.

In the above embodiments, the exposing unit 5 includes the exposing components 3Y, 3M, 3C, and 3Bk, and the printer 100 is configured as a one-pass image forming apparatus that forms a multicolor image while the photoconductive drum 1, 11 rotates once. However, the present invention may also be applied to an image forming apparatus that forms a multicolor image by rotating a photoconductive drum multiple times. For example, the present invention may be applied to a four-pass image forming apparatus that forms a multicolor image by rotating a photoconductive drum four times. Such a four-pass image forming apparatus may be designed to include the developing unit 4 for each color and only one charging unit 2 for the photoconductive drum 1. This configuration makes it possible to reduce the size and production costs of an image forming apparatus. The present invention may be applied not only to a four-color image forming apparatus but also to any image forming apparatus that forms a multicolor image using two or more colors by the image-on-image development method (e.g., a three-color image forming apparatus using yellow, magenta, and cyan toners). In the above embodiments, the exposing unit 5 is configured to expose the photoconductive drum 1, 11 through a preceding toner image (toner layer). The present invention may also be applied to an image forming apparatus including an exposing unit that exposes a photoconductive drum from the back side (where no toner image is formed). Further, although the photoconductive drum 1, 11 is used as an image carrier in the above embodiments, an image carrier may be implemented by a photoconductive belt.

According to embodiments of the present invention, a latent image forming unit assigned to a first color forms a latent image by exposing non-image areas of an image carrier charged by a charging unit assigned to the first color, and a developing unit assigned to the first color develops the latent image with a toner having a polarity opposite to that of the charged image carrier. This process is repeated for the number of colors and, as a result, a color toner image composed of toner images of the respective colors is formed on the image carrier. Assuming that a color toner image is composed of two colors, the toner image of the first color formed on the image carrier through a first process is charged together with the image carrier by a charging unit assigned to a second color to a polarity opposite to that of toner in a second process. In other words, the charging unit assigned to the second color charges the image carrier to a predetermined potential (the same as that in the first process) and at the same time discharges the toner image of the first color. This configuration eliminates the need to provide a dedicated discharging unit to discharge a toner image. Meanwhile, image areas on the image carrier where the toner image of the first color is formed are not exposed and therefore retain the same surface potential as that when the image carrier is charged by the charging unit in the first process. Therefore, discharging the toner image of the first color makes the development potential differences in a toner-image-present portion, where the first toner image is present, and a toner-image-absent portion, where the first toner image is not present, of a latent image to be formed in the second process substantially the same. This in turn makes it possible to form the toner image of the second color with a uniform density. This method can also be applied to a case where a color toner image is composed of toner images of three or more colors.

The present invention is not limited to the specifically disclosed embodiments, and variations and modifications may be made without departing from the scope of the present invention.

The present application is based on Japanese Priority Application No. 2007-055998, filed on Mar. 6, 2007, the entire contents of which are hereby incorporated herein by reference.

What is claimed is:

1. An image forming apparatus, comprising:
an image carrier;
one or more charging units configured to charge the image carrier in preparation for formation of each of plural latent images corresponding to toner images of different colors;
a latent image forming unit configured to expose non-image areas on the charged image carrier to form each of the latent images; and
developing units configured to develop the corresponding latent images in sequence with toners of the corresponding colors to form the toner images and thereby to form a color toner image composed of the toner images of the different colors on the image carrier, the toners having polarity opposite to that of the charged image carrier.

2. The image forming apparatus as claimed in claim 1, wherein multiple image forming units each including one of the charging units and a corresponding one of the developing units are disposed along a surface of the image carrier, the corresponding one of the developing units being disposed downstream of the one of the charging units with respect to a movement direction of the surface of the image carrier.

3. The image forming apparatus as claimed in claim 1, wherein the charging units are configured to charge the image carrier to positive polarity.

4. The image forming apparatus as claimed in claim 1, wherein the charging units are configured to charge the image carrier to negative polarity.

5. The image forming apparatus as claimed in claim 1, wherein the charging units are configured to charge without contact the image carrier.

6. The image forming apparatus as claimed in claim 1, further comprising:
a power supply unit configured to supply a direct current voltage to the charging units.

7. The image forming apparatus as claimed in claim 1, wherein
each of the developing units includes a toner carrier disposed to face the image carrier in a developing zone but not to contact the image carrier and configured to carry a corresponding one of the toners;
the toner carrier includes electrodes disposed along a surface thereof and insulated from each other; and
the electrodes are categorized into two or more groups and voltages having a predetermined phase difference therebetween are applied to the respective groups so that the electrodes function as a hopping electric field generating unit that causes the corresponding one of the toners to hop between the electrodes.

8. The image forming apparatus as claimed in claim 7, wherein the toner carrier is configured to carry the corresponding one of the toners by movement of the toner carrier surface to the developing zone.

9. The image forming apparatus as claimed in claim 7, wherein the hopping electric field generating unit is configured to generate a progressive-wave electric field that causes the corresponding one of the toners on the toner carrier to hop between the electrodes and thereby to move to the developing zone.

10. A process cartridge attachable to and detachable from an image forming apparatus, the process cartridge comprising:
the image carrier, the charging units, and/or the developing units of the image forming apparatus of claim 1.

11. A method for forming a color toner image composed of multiple toner images of different colors on an image carrier of an image forming apparatus, the method comprising the steps of:
charging the image carrier in preparation for formation of each of latent images corresponding to the toner images of the different colors;
exposing non-image areas on the charged image carrier to form each of the latent images; and
developing the latent images in sequence with toners of the corresponding colors to form the toner images and thereby to form the color toner image on the image carrier, the toners having polarity opposite to that of the charged image carrier.
